(19) United States
(12) Patent Application Publication
(10) Pub. No.: US 2026/0204229 A1
(43) Pub. Date: Jul. 16, 2026

(54) DATA DRIVING DEVICE AND DISPLAY DEVICE

(71) Applicant: LX SEMICON CO., LTD., Daejeon (KR)

(72) Inventors: Byeong Ho JEONG, Daejeon (KR); Kwang Seok PARK, Daejeon (KR)

(73) Assignee: LX SEMICON CO., LTD., Daejeon (KR)

(21) Appl. No.: 19/136,492

(22) PCT Filed: Dec. 5, 2023
(86) PCT No.: PCT/KR2023/019867

§ 371 Date: Jun. 6, 2025

(30) Foreign Application Priority Data
Dec. 8, 2022 (KR) 10-2022-0170421
Dec. 4, 2023 (KR) 10-2023-0173836

(51) Int. Cl. G09G 3/3275

(52) U.S. Cl. CPC G09G 3/3275; G09G 2310/027; G09G 2310/0289; G09G 2310/0291; G09G 2320/0252; G09G 2330/021; G09G 2354/00

(57) ABSTRACT

A data driving device may include a selection circuit, an amplifier, a plurality of switches, and a slew boost circuit. The selection circuit may select q (<p) divided voltages from among p divided voltages in response to a k (<j) bit image code constituting a j bit digital data signal. The amplifier may output an analog data signal using the output voltage. The slew boost circuit may receive one divided voltage from among the q divided voltages and output a control signal to the plurality of switches using the one divided voltage.

### TECHNICAL FIELD

The embodiment relates to a data driving device and a display device.

### BACKGROUND ART

As informatization progresses, various display devices capable of visualizing information are being developed.

The display device includes a data driving device configured to generate a data signal supplied to a panel. The data driving device outputs a data signal corresponding to a digital signal having a grayscale value using a gamma voltage onto the panel.

Recently, various technologies for improving color reproducibility have been developed as high-quality images are strongly demanded.

For example, color reproducibility may be improved by increasing the number of bits of a digital signal and providing a more detailed data signal to the panel.

As the number of bits of a digital signal increases, the circuit area increases exponentially. To solve this problem, an interpolation scheme that uses some bits of a digital signal as an interpolation code value has been proposed.

Although the increase in circuit area was suppressed through the interpolation scheme, there was a problem that the output speed of the output buffer was limited. In order to solve this, when the area of the routing input to the output buffer or the number of metals is increased, there is a problem that the price competitiveness is reduced and the development cost is increased.

### DISCLOSURE

### Technical Problem

An object of the embodiment is to solve the foregoing and other problems.

Another object of the embodiment is to provide a data driving device and a display device capable of increasing color reproducibility and suppressing the increase in circuit area.

Another object of the embodiment is to provide a data driving device and a display device capable of increasing the output speed.

Another object of the embodiment is to provide a data driving device and a display device capable of improving the settling time.

Another object of the embodiment is to provide a data driving device and a display device capable of high-speed driving.

The technical problems of the embodiments are not limited to those described in this item and include those that may be understood through the description of the invention.

### Technical Solution

According to one aspect of the embodiment to achieve the above or other objects, a data driving device, comprising: a selection circuit configured to select q (<p) divided voltages from among p divided voltages in response to a k (<j) bit image code constituting a j-bit digital data signal; a plurality of switches connected to the selection circuit and configured to output voltages; an amplifier configured to output an analog data signal using the output voltages; and a slew boost circuit configured to receive one divided voltage from among the q divided voltages and configured to output a control signal to the plurality of switches using the one divided voltage.

Each of the plurality of switches may be connected to two or more signal lines from among the q signal lines connected to the selection circuit, and may receive two or more divided voltages provided through the two or more signal lines in response to the control signal during a first period, and output one divided voltage from among the two or more divided voltages as an output voltage.

The slew boost circuit may obtain the control signal based on the input one divided voltage and a previous analog data signal output from the amplifier.

A level of the control signal is configured to vary according to a difference between the input one divided voltage and the previous analog data signal.

A divided voltage selected from each of the plurality of switches may vary according to the level of the control signal.

The data driving device may comprise a control signal generation circuit that generates the control signal.

The control signal generation circuit may generate the control signal having a different level based on a difference between an input one divided voltage and a previous analog data signal output from the amplifier.

The control signal generation circuit may comprise an integrator or at least one inverter.

The q divided voltages may comprise a first reference voltage, a second reference voltage, and remaining voltages, and each of the plurality of switches may select one voltage from among the first reference voltage and the second reference voltage as an output voltage in response to an (j-k)-bit interpolation code constituting the j-bit digital data signal for a second period and output the selected output voltage to the amplifier.

According to another aspect of the embodiment to achieve the above or other objects, a display device, comprising: a panel comprising a plurality of gate lines and a plurality of data lines; and a data driving device configured to drive the plurality of data lines, wherein the data driving device comprises: a selection circuit configured to select q (<p) divided voltages from among p divided voltages in response to a k (<j) bit image code constituting a j-bit digital data signal; a plurality of switches connected to the selection circuit and configured to output voltages; an amplifier configured to output an analog data signal using the output voltages; and a slew boost circuit configured to receive one divided voltage from among the q divided voltages and configured to output a control signal to the plurality of switches using the one divided voltage.

### Advantageous Effects

The effects of the data driving device and the display device according to the embodiment are described as follows.

According to at least one of the embodiments, a plurality of switches may be connected to at least two or more signal lines among a plurality of signal lines that supply a plurality of divided voltages, respectively. Therefore, since each of the plurality of switches outputs one of the plurality of divided voltages as an output voltage to an amplifier during a first period distinguished by using a vertical synchronization signal, the settling time can be improved, so that the output speed of the amplifier can be increased, thereby enabling high-speed driving.

According to at least one of the embodiments, since a first divided voltage (a first reference voltage) and a second divided voltage (a second reference voltage) selected by each of the plurality of switches during a second period distinguished by using a vertical synchronization signal are interpolated, color reproducibility can be improved and an increase in the circuit area can be suppressed.

According to at least one of the embodiments, by independently using one of the plurality of divided voltages output from a selection circuit as an input to a slew boost circuit and/or the amplifier, the control current of the slew boost circuit and/or the amplifier can be increased or decreased more quickly. Therefore, the settling time can be improved by the independent divided voltage input to the slew boost circuit and/or the amplifier, thereby increasing the output speed of the amplifier.

According to at least one of the embodiments, by generating a control signal for controlling the operation of the plurality of switches in the slew boost circuit, an additional circuit area for digital logic for generating the control signal may not be required.

According to at least one of the embodiments, by directly providing the control signal generated in the slew boost circuit to the plurality of switches, the signal transmission path can be minimized, thereby preventing malfunction due to signal loss.

### DESCRIPTION OF DRAWINGS

FIG. 1 is a block diagram illustrating a display device according to an embodiment.

FIG. 2 is a block diagram illustrating a data driving device according to a first embodiment.

FIG. 3 is an operation timing diagram of a data driving device according to the first embodiment.

FIG. 4 is a table illustrating input signals and output signals of an amplifier of FIG. 2.

FIG. 5 is a graph illustrating voltages according to digital signals for q divided voltages input to an output buffer.

FIG. 6 is a block diagram illustrating a data driving device according to a second embodiment.

FIG. 7 is a block diagram illustrating a slew boost circuit and an amplifier of FIG. 6.

FIG. 8 is an operation timing diagram of a data driving device according to the second embodiment.

FIG. 9 is a block diagram illustrating a data driving device according to a third embodiment.

FIG. 10 is a block diagram illustrating a slew boost circuit and an amplifier of FIG. 9.

FIG. 11 is an operation timing diagram of a data drive device according to the third embodiment.

The sizes, shapes, dimensions, etc. of elements illustrated in the drawings may differ from actual ones. In addition, even if the same elements are illustrated in different sizes, shapes, dimensions, etc. between the drawings, this is only an example on the drawing, and the same elements have the same sizes, shapes, dimensions, etc. between the drawings.

### MODE FOR INVENTION

Hereinafter, the embodiment disclosed in this specification will be described in detail with reference to the accompanying drawings, but the same or similar elements are given the same reference numerals regardless of reference numerals, and redundant descriptions thereof will be omitted. The suffixes ‘module’ and ‘unit’ for the elements used in the following descriptions are given or used interchangeably in consideration of ease of writing the specification, and do not themselves have a meaning or role that is distinct from each other. In addition, the accompanying drawings are for easy understanding of the embodiment disclosed in this specification, and the technical idea disclosed in this specification is not limited by the accompanying drawings. Also, when an element such as a layer, region or substrate is referred to as being ‘on’ another element, this means that there may be directly on the other element or be other intermediate elements therebetween.

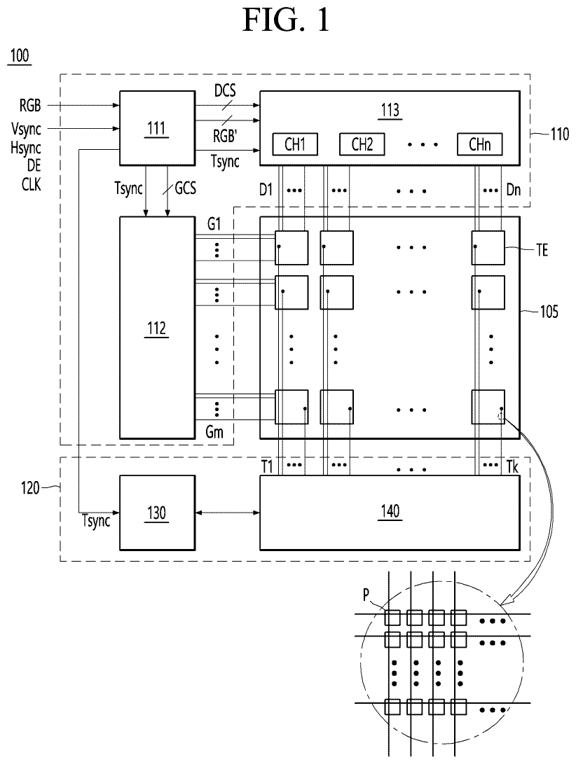

FIG. 1 is a block diagram illustrating a display device according to an embodiment.

Referring to FIG. 1, the display device 100 according to an embodiment may comprise a panel 105, a display driving device 110, a touch driving device 120, etc.

A display device 100 according to an embodiment may perform a display function and a touch sensing function.

The panel 105 may comprise a plurality of touch sensors TE capable of outputting a sensing signal for touching or approaching an object. The panel 105 may comprise, but is not limited to, an organic light-emitting diode.

The panel 105 may comprise a plurality of gate lines G1 to Gm, a plurality of data lines D1 to Dn, a plurality of pixels P, a plurality of touch sensors TE, a plurality of touch lines T1 to Tk, etc.

The plurality of gate lines Gl to Gm and the plurality of data lines D1 to Dn may be connected to a plurality of pixels P on the substrate. The plurality of gate lines G1 to Gm may receive scan pulses during a display period. The plurality of data lines DI to Dn may receive data signals during a display period.

The display driving device 110 may supply data signals to the plurality of pixels P so that an image may be displayed on the panel 105 during a display period. The display driving device 110 may comprise a data processing device 111, a gate driving device 112, a data driving device 113, etc. The data processing device 111 may comprise a timing controller, etc.

The data processing device 111 may receive various timing signals from the host system. The timing signals may comprise a vertical synchronization signal Vsync, a horizontal synchronization signal Hsync, a data enable signal DE, a clock signal CLK, etc. The data processing device 111 may generate various control signals based on the timing signals.

The data processing device 111 may receive an image signal, i.e., digital image data RGB, from the host system and convert it into an image signal RGB′ in a form that may be processed by the data driving device 113.

The data processing device 111 may generate a touch synchronization signal Tsync using the clock signal CLK, the vertical synchronization signal Vsync, the data enable signal, etc.

The gate driving device 112 may receive a gate control signal GCS from the data processing device 111. The gate driving device 112 may generate a scan pulse in response to the gate control signal GCS.

The data driving device 113 may receive a data control signal DCS and an image signal RGB′ from the data processing device 111. The data driving device 113 may convert the image signal RGB′ into an analog data signal using the data control signal DCS, and supply the data signal to the pixels P through a plurality of data lines D1 to Dn.

The data driving device 113 may comprise a plurality of channels CHI to CHn. The plurality of channels CHI to CHn may be connected to a plurality of data lines D1 to Dn, respectively. The plurality of channels CHI to CHn may generate a data signal to be supplied to a plurality of data lines D1 to Dn, respectively.

The touch driving device 120 may comprise a touch controller 130, a touch sensing circuit 140, etc. The touch controller 130 may be named a touch microcontroller unit, etc.

The touch controller 130 may perform a touch sensing operation during a touch period. The touch controller 130 may control the touch sensing circuit 140 to perform the touch sensing operation during the touch period.

The touch controller 130 may obtain touch coordinates based on a touch sensing signal received through the touch sensing circuit 140, and may execute an application program corresponding to the touch coordinates or perform a corresponding operation. The touch controller 130 may transmit information comprising the touch coordinates to the data processing device 111. In this instance, the data processing device 111 may execute an application program corresponding to the touch coordinates or perform a corresponding operation based on information comprising the touch coordinates received from the touch controller 130.

### First Embodiment

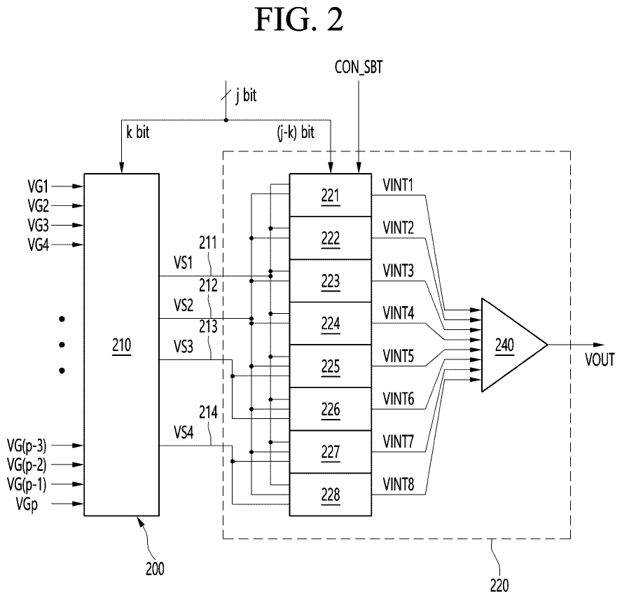

FIG. 2 is a block diagram illustrating a data driving device according to a first embodiment.

Referring to FIGS. 1 and 2, the data driving device according to the first embodiment may comprise a digital-to-analog converter 200, an output buffer 220, etc. The digital-to-analog converter 200 and the output buffer 220 may be included in one of the plurality of channels CHI to CHn illustrated in FIG. 1. The plurality of channels CHI to CHn may each comprise a digital-to-analog converter 200 and an output buffer 220.

The data driving device according to the first embodiment may comprise a first latch circuit, a second latch circuit, a voltage level shifter, etc. The voltage level shifter may be connected to a front end of the digital-to-analog converter 200, the second latch circuit may be connected to a front end of the voltage level shifter, and the first latch circuit may be connected to a front end of the second latch circuit.

The digital-to-analog converter 200 may output an analog data signal VOUT corresponding to a digital data signal. The output buffer 220 may amplify and output the analog data signal VOUT. The output buffer 220 may change a slew rate of the analog data signal VOUT to drive at low power without increasing the current consumption. The output buffer 220 may achieve a fast settling time to increase the output speed of the analog data signal VOUT.

In an embodiment, the digital data signal may consist of j bits. The digital data signal of j bits may consist of a high-bit signal and a low-bit signal. In this instance, the high-bit signal may represent a k-bit (<j) image code, and the low-bit signal may represent a (j-k)-bit interpolation code. For example, when the digital data signal consists of 11 bits, a high-bit signal having a 8-bit may represent a k-bit image code, and a low-bit signal having 3 bits may represent a (j-k)-bit interpolation code. The k-bit image code may correspond to a bit value of the high-bit signal having 8 bits, and the (j-k)-bit interpolation code may correspond to a bit value of the low-bit signal having 3 bits.

As illustrated in FIG. 2, the k-bit image code may be provided to the digital-to-analog converter 200, and the (j-k)-bit interpolation code may be provided to the output buffer 220.

The digital-to-analog converter 200 may select q (<p) divided voltages VS1 to VS4 among p divided voltages VG1 to VGp in response to the k-bit image code, and provide q (<p) divided voltages VS1 to VS4 to the output buffer 220. The digital-to-analog converter 200 may comprise a selection circuit 210, etc. The selection circuit 210 may select the q divided voltages VS1 to VS4 among the p divided voltages VG1 to VGp in response to the k-bit image code, and provide the q divided voltages VS1 to VS4 to the output buffer 220.

The number of k-bit image code and the number of p divided voltage VG1 to VGp may be the same, but is not limited thereto. For example, in the case of an 8-bit image code, 256 different divided voltages may be provided. The 256 divided voltages may be positioned on a gamma curve, and since the gamma curve is nonlinear, the difference value between the 256 divided voltages may be nonlinear, but is not limited thereto.

As illustrated in FIG. 2, the q divided voltages VS1 to VS4 may comprise a first divided voltage VS1, a second divided voltage VS2, a third divided voltage VS3, and a fourth divided voltage VS4, but more divided voltages may be also included. For example, the second divided voltage VS2 may be greater than the first divided voltage VS1, the third divided voltage VS3 may be greater than the second divided voltage VS2, and the fourth divided voltage VS4 may be greater than the third divided voltage VS3, but is not limited thereto.

The selection circuit 210 may select the first divided voltage VS1 in response to a k-bit image code. In this instance, the second divided voltage VS2 to the fourth divided voltage VS4 may each be selected based on a k-bit image code.

As an example, the selection circuit 210 may select the second divided voltage VS2, the third divided voltage VS3, and the fourth divided voltage VS4 in response to a code value (or bit value) that is one bit higher than the k-bit image code used to select the first divided voltage VS1, respectively. For example, when the k-bit image code is 00000000, the selection circuit 210 may select the first divided voltage VS1 in response to 00000000. In this instance, the selection circuit 210 may select the second divided voltage VS2, the third divided voltage VS3, and the fourth divided voltage VS4 in response to 00000010, 00000011, and 00000100, respectively, which are one bit higher than 00000000.

As another example, the selection circuit 210 may select the second divided voltage VS2, the third divided voltage VS3, and the fourth divided voltage VS4 in response to a code value (or bit value) that is 2-bit higher than the k-bit image code used to select the first divided voltage VS1, respectively. For example, when the k-bit image code is 00000000, the selection circuit 210 may select the first divided voltage VS1 in response to 00000000. In this instance, the selection circuit 210 may select the second divided voltage VS2, the third divided voltage VS3, and the fourth divided voltage VS4 in response to 00000010, 00000100, and 00000110, respectively, which are 2-bit higher than 00000000.

In addition, the selection circuit 210 may select the second divided voltage VS2, the third divided voltage VS3, and the fourth divided voltage VS4 in response to a code value (or bit value) that is higher by 3 bits, 5 bits, etc. than the image code of k bits, respectively. The number of bits by which the selection circuit 210 selects the second divided voltage VS2, the third divided voltage VS3, and the fourth divided voltage VS4 in response to a code value that is higher by several bits than the image code of k bits may be programmed in advance and recorded in a register, etc. The corresponding bit unit may be changed through the register.

The q divided voltages VS1 to VS4 may comprise a first reference voltage VS1, a second reference voltage VS2, and the remaining reference voltages VS3 and VS4. The above-mentioned first divided voltage VS1 may be the first reference voltage, and the second divided voltage VS2 may be the second reference voltage. Hereinafter, the first divided voltage VS1 and the first reference voltage may be used interchangeably, and the second divided voltage VS2 and the second reference voltage may be used interchangeably. Hereinafter, the remaining reference voltages VS3 and VS4 may refer to the third divided voltage VS3 and the fourth divided voltage VS4.

The first reference voltage VS1 and the second reference voltage VS2 may be used to perform interpolation in the output buffer 220. The first reference voltage VS1, the second reference voltage VS2, and the remaining reference voltages VS3 and VS4 may be used to improve the settling time and increase the output speed of the output buffer 220.

Meanwhile, the output buffer 220 may be connected to the selection circuit 210. Q signal lines 211 to 214 may be connected between the selection circuit 210 and the output buffer 220. For example, the first divided voltage VS1 may be provided from the selection circuit 210 to the output buffer 220 through a first signal line 211, and the second divided voltage VS2 may be provided from the selection circuit 210 to the output buffer 220 through a second signal line 212. For example, the third divided voltage VS3 may be provided from the selection circuit 210 to the output buffer 220 through a third signal line 213, and the fourth divided voltage VS4 may be provided from the selection circuit 210 to the output buffer 220 through a fourth signal line 214.

The output buffer 220 may comprise a plurality of switches 221 to 228, an amplifier 240, etc.

An (j-k)-bit interpolation code may be provided to the plurality of switches 221 to 228. Accordingly, the plurality of switches 221 to 228 may select one of the first reference voltage VS1 and the second reference voltage VS2 as output voltages VINT1 to VINT8 in response to the (j-k)-bit interpolation code, and output the selected output voltages VINTI to VINT8 to the amplifier 240.

The number of switches 221 to 228 may be determined based on (j-k) bits. As described above, when j is 11 and k is 8, the interpolation code has 3 bits, so that 2³, i.e., 8 switches may be provided. When k is 7, the interpolation code has 4 bits, so that 2⁴, i.e., 16 switches may be provided.

The q signal lines 211 to 214 may be connected to the plurality of switches 221 to 228.

As an example, as illustrated in FIG. 2, the first signal line 211 and the second signal line 212 may be commonly connected to the plurality of switches 221 to 228, respectively, and the third signal line 213 and the fourth signal line 214 may be connected to some of the plurality of switches 221 to 228, respectively, but is not limited thereto. For example, the first signal line 211 may be commonly connected to the plurality of switches 221 to 228. Accordingly, the first divided voltage VS1 may be simultaneously provided to the plurality of switches 221 to 228 through the first signal line 211. For example, the second signal line 212 may be commonly connected to the plurality of switches 221 to 228. Accordingly, the second divided voltage VS2 may be simultaneously provided to the plurality of switches 221 to 228 through the second signal line 212.

For example, the third signal line 213 may be connected to some of the switches 221 to 228. For example, the third signal line 213 may be connected to the fifth switch 225 and the sixth switch 226, but is not limited thereto. Accordingly, the third divided voltage VS3 may be simultaneously provided to the fifth switch 225 and the sixth switch 226 through the third signal line 213. For example, the fourth signal line 214 may be connected to some of the switches 221 to 228. For example, the fourth signal line 214 may be connected to the seventh switch 227 and the eighth switch 228, but is not limited thereto. Accordingly, the fourth divided voltage VS4 may be simultaneously provided to the seventh switch 227 and the eighth switch 228 through the fourth signal line 214.

As another example, the third signal line 213 may be connected to the seventh switch 227 and the eighth switch 228, and the fourth signal line 214 may be connected to the fifth switch 225 and the sixth switch 226. As another example, the third signal line 213 and/or the fourth signal line 214 may be commonly connected to the plurality of switches 221 to 228.

Meanwhile, the plurality of switches 221 to 228 may be connected to two or more signal lines among the q signal lines 211 to 214, respectively. That is, the plurality of switches 221 to 228 may comprise two or more input terminals connected to two or more signal lines, respectively. Accordingly, the plurality of switches 221 to 228 may receive two or more divided voltages through two or more signal lines, respectively.

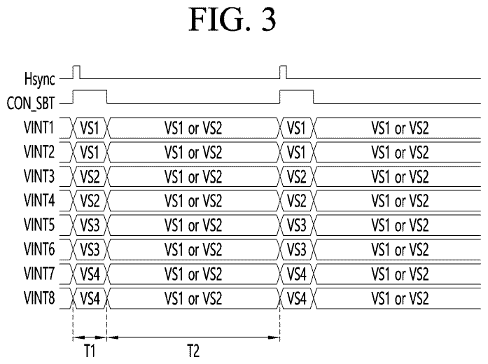

For example, the first switch 221, the second switch 222, the third switch 223, and the fourth switch 224 may each comprise a first input terminal connected to the first signal line 211 and a second input terminal connected to the second signal line 212. Accordingly, during a first period (T1 in FIG. 3) or during a second period T2, the first switch 221, the second switch 222, the third switch 223, and the fourth switch 224 may each select one of the first divided voltage VS1 and the second divided voltage VS2 provided through the first signal line 211 and the second signal line 212 as the output voltage VINT1 to VINT4.

For example, the fifth switch 225 and the sixth switch 226 may each comprise a first input terminal connected to the first signal line 211, a second input terminal connected to the second signal line 212, and a third input terminal connected to the third signal line 213. Accordingly, during the first period T1, the fifth switch 225 and the sixth switch 226 may each select one of the first divided voltage VS1, the second divided voltage VS2, and the third divided voltage VS3 provided through the first signal line 211, the second signal line 212, and the third signal line 213 as the output voltage VINT5 and VINT6. Additionally, during the second period T2, the fifth switch 225 and the sixth switch 226 may select one of the first divided voltage VS1 and the second divided voltage VS2 provided through the first signal line 211 and the second signal line 212, respectively, as the output voltage VINT5 and VINT6.

For example, the seventh switch 227 and the eighth switch 228 may each comprise a first input terminal connected to the first signal line 211, a second input terminal connected to the second signal line 212, and a third input terminal connected to the fourth signal line 214. Accordingly, during the first period T1, the seventh switch 227 and the eighth switch 228 may select one of the first divided voltage VS1, the second divided voltage VS2, and the fourth divided voltage VS4 provided through the first signal line 211, the second signal line 212, and the fourth signal line 214 as the output voltage VINT7 and VINT8, respectively. In addition, during the second period T2, the seventh switch 227 and the eighth switch 228 may select one of the first divided voltage VS1 and the second divided voltage VS2 provided through the first signal line 211 and the second signal line 212, respectively, as the output voltage VINT7 and VINT8.

Meanwhile, As illustrated in FIG. 3, the first period T1 and the second period T2 may be distinguished using the horizontal synchronization signal Hsync. The horizontal synchronization signal Hsync may be defined as a time for supplying an analog data signal VOUT to a pixel P activated by a scan pulse provided to a specific gate line among the plurality of gate lines G1 to Gm illustrated in FIG. 1. Therefore, the analog data signal VOUT may be supplied onto the panel 105 for every horizontal synchronization signal Hsync.

The plurality of switches 221 to 228 may be switched and controlled according to a control signal CON_SBT during the first period T1, and may be switched and controlled according to an (j-k)-bit interpolation code during the second period T2.

The first period T1 may be a settling time, which may also be referred to as an initialization time or a pre-charging time. That is, the first period T1 may be a time for settling a voltage on an input side of the amplifier 240 to a specific voltage level. A fast settling time may be required in order to increase the output speed of the amplifier 240. During the first period T1, an input signal on the input side of the output buffer 220 may be initialized or pre-charged to a specific voltage level. Therefore, by initializing or pre-charging to a specific voltage level in a short time, an output signal of a desired grayscale may be quickly output, thereby increasing the output speed. For example, the specific voltage level may be a median value between the first divided voltage VS1 and the second divided voltage VS2, or an average value of the first divided voltage VS1 and the second divided voltage VS2, but is not limited thereto.

The second period T2 may be a stabilization time, which may be a time for quickly transitioning the specific voltage level obtained during the first period T1 to an analog data signal VOUT of a desired grayscale, and stably providing the transitioned analog data signal VOUT onto the panel 105.

Therefore, in order to stably provide the analog data signal VOUT to the panel 105, it should be initialized to a specific voltage level more quickly during the first period T1, and transitioned to the desired analog data signal VOUT from a specific voltage level more quickly during the second period T2.

When a specific voltage level is not reached during the first period T1 or the time for reaching the specific voltage level is delayed, the analog data signal VOUT of the desired grayscale is not transitioned to the specific voltage level during the second period T2, so that an analog data signal VOUT of a different grayscale from the desired grayscale is provided on the panel 105, which may cause poor image quality.

According to the embodiment, during the first period T1, a plurality of switches 221 to 228 may be used to provide more diverse divided voltages VS1 to VS4 to the input side of the amplifier 240, so that a faster settling time can be achieved. That is, during the first period T1, the plurality of switches 221 to 228 may select not only the first divided voltage VS1 and the second divided voltage VS2, but also the third divided voltage VS3 and the fourth divided voltage VS4, so that the first divided voltage VS1 to the fourth divided voltage VS4 may be provided to the amplifier 240, so that a specific voltage level can be obtained more quickly and the settling time can be improved. Accordingly, the output speed of the output buffer 220 can be increased, enabling high-speed driving.

Referring to FIG. 2 and FIG. 3, during the first period T1, a plurality of switches 221 to 228 may be operated according to a control signal CON_SBT. The control signal CON_SBT may be generated, for example, by a data processing device 111, for example, a timing controller, but is not limited thereto.

The plurality of switches 221 to 228 may perform switching control to select one of the first divided voltage VS1, the second divided voltage VS2, the third divided voltage VS3, and the fourth divided voltage VS4 as the output voltage VINT1 to VINT8 according to the control signal CON_SBT.

As illustrated in FIG. 2, the first switch 221 may select the first divided voltage VS1 in response to the control signal CON_SBT and provide the selected first divided voltage VS1 as the first output voltage VINT1 to the amplifier 240. For example, the second switch 222 may select the first divided voltage VS1 in response to the control signal CON_SBT and provide the selected divided voltage as the second output voltage VINT2 to the amplifier 240. For example, the third switch 223 may select the second divided voltage VS2 in response to the control signal CON_SBT and provide the selected second divided voltage VS2 as the third output voltage VINT3 to the amplifier 240. For example, the fourth switch 224 may select the second divided voltage VS2 in response to the control signal CON_SBT and provide the selected second divided voltage VS2 as the fourth output voltage VINT4 to the amplifier 240.

The fifth switch 225 may select the third divided voltage VS3 in response to the control signal CON_SBT and provide the selected third divided voltage VS3 as the fifth output voltage VINT5 to the amplifier 240. For example, the sixth switch 226 may select the third divided voltage VS3 in response to the control signal CON_SBT and provide the selected third divided voltage VS3 as the sixth output voltage VINT6 to the amplifier 240. For example, the seventh switch 227 may select the fourth divided voltage VS4 in response to the control signal CON_SBT and provide the selected fourth divided voltage VS4 as the seventh output voltage VINT7 to the amplifier 240. The eighth switch 228 may select the fourth divided voltage VS4 in response to the control signal CON_SBT and provide the selected fourth divided voltage VS4 as the eighth output voltage VINT8 to the amplifier 240.

Accordingly, the amplifier 240 may receive not only the first divided voltage VS1 and the second divided voltage VS2, but also the third divided voltage VS3 and the fourth divided voltage VS4, which are greater than the second divided voltage VS2, so that the input signal on the input side of the amplifier 240 can be quickly initialized or pre-charged to a specific voltage level using these divided voltages VS1 to VS4. When the input side of the amplifier 240 is initialized to a specific voltage level, the output side of the amplifier 240 may also be changed to a specific voltage level. That is, the previous analog data signal output to the output side of the amplifier 240 may be changed to a specific voltage level. By quickly initializing or pre-charging the input signal on the input side of the amplifier 240 to a specific voltage level, the settling time can be improved, so that the output speed of the amplifier 240 can be increased.

Meanwhile, not only the first signal line 211 and the second signal line 212, but also the third signal line 213 and the fourth signal line 214 may be commonly connected to the first switch 221 to the eighth switch 228. In this instance, the plurality of switches 221 to 228 may each select one of the first divided voltages VS1 to the fourth divided voltages VS4 as the output voltage VINTI to VINT8, and provide the selected output voltages VINT1 to VINT8 to the amplifier 240. For example, the first switch 221 to the fourth switch 224 may each provide the second divided voltage VS2 to the amplifier 240, and the fifth switch 225 to the eighth switch 228 may each provide the fourth divided voltage VS4 to the amplifier 240. For example, the plurality of switches 221 to 228 may each provide the third divided voltage VS3 to the amplifier 240. For example, the plurality of switches 221 to 228 may provide the fourth divided voltage VS4 to the amplifier 240.

Meanwhile, the divided voltage selected from each of the plurality of switches 221 to 228 may vary depending on the difference between the previous analog data signal output from the amplifier 240 and the current analog data signal. The control signal CON_SBT may comprise information on which of the divided voltage should be selected by each of the switches 221 to 228, based on the difference between the previous analog data signal and the current analog data signal. The previous analog data signal may be a signal supplied onto the panel 105 during the previous frame, and the current analog data signal may be a signal to be supplied onto the panel 105 during the current frame. The previous analog data signal may be an analog data signal output from the amplifier 240, and the current analog data signal may be an analog data signal to be input to the amplifier 240 during the second period T2.

For example, when the difference between the previous analog data signal output from the amplifier 240 and the current analog data signal is very large, each of the first switch 221 to the eighth switch 228 may select the fourth divided voltage VS4 among the first divided voltage VS1 to the fourth divided voltage VS4 during the first period T1, and provide the selected fourth divided voltages VS4 to the amplifier 240. Accordingly, since the input signal of the amplifier 240 is set to a specific voltage level very quickly, it is possible to more easily reach a level of the current analog data signal during the second period T2, thereby preventing image quality degradation.

For example, when the difference between the previous analog data signal output from the amplifier 240 and the current analog data signal is very small, each of the first switch 221 to the eighth switch 228 may select the first divided voltage VS1 among the first divided voltage VS1 to the fourth divided voltage VS4 during the first period T1, and provide the selected first divided voltages VS1 to the amplifier 240. Accordingly, the input signal of the amplifier 240 may be set to a specific voltage level relatively slowly. Even if the input signal of the amplifier 240 is set to a specific voltage level relatively slowly, since the difference between the previous analog data signal and the current analog data signal is small, a level of the current analog data signal may be more easily reached during the second period T2, thereby preventing image quality degradation.

According to the embodiment, since the divided voltages selected from the plurality of switches 221 to 228 vary depending on the difference between the previous analog data signal and the current analog signal, low-power operation can be achieved without increasing current consumption, while preventing degradation in image quality.

Meanwhile, referring back to FIG. 2 and FIG. 3, during the second period T2, the plurality of switches 221 to 228 may be operated according to the (j-k) bit interpolation code. The (j-k) bit interpolation code may be a low-bit signal of a j-bit digital data signal.

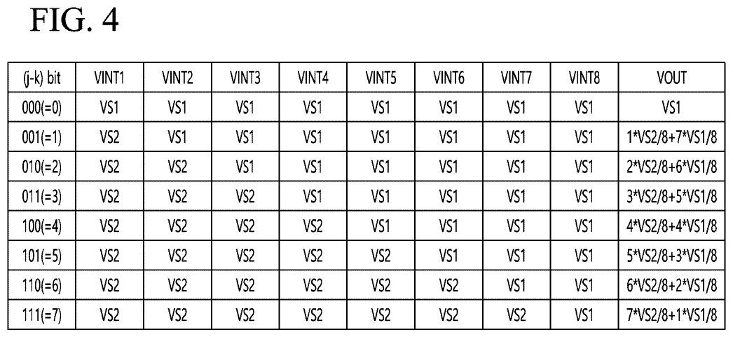

As illustrated in FIG. 4, when the (j-k) bit interpolation code is 000, the plurality of switches 221 to 228 may output the first divided voltage VS1 as the first output voltage VINT1 to the eighth output voltage VINT8 to the amplifier 240, respectively. The amplifier 240 may interpolate the first divided voltages VS1 received as the first output voltage VINT1 to the eighth output voltage VINT8 and output the first divided voltage VS1 as an analog data signal VOUT corresponding to the first divided voltage VS1.

When the (j-k)-bit interpolation code is 001, the first switch 221 may select the second divided voltage VS2, and the second switch 222 to the eighth switch 228 may each select the first divided voltage VS1. The amplifier 240 may interpolate one second divided voltage VS2 and seven first divided voltages VS1 to output an analog data signal VOUT corresponding to (1*VS2/8+7*VS1/8).

In this way, when the (j-k)-bit interpolation code is 111, the first switch 221 to the seventh switch 227 may select the second divided voltage VS2, and the eighth switch 228 may select the first divided voltage VS1. The amplifier 240 may interpolate seven second divided voltages VS2 and one first divided voltage VS1 to output an analog data signal VOUT corresponding to (7*VS2/8+1*VS1/8).

Meanwhile, the amplifier 240 may interpolate the first output voltage VINT1 to the eighth output voltage VINT8 output from each of the plurality of switches 221 to 228 during the second period to generate 2^{(j-k)} analog data signals VOUT. For example, when using a 3-bit interpolation code, the amplifier 240 may output 8 analog data signals VOUT.

As described above, since 256 first reference voltages VS1 are output using an 8-bit image code, 2048 analog data signals VOUT may be generated using an 11-bit digital data signal composed of an 8-bit image code and a 3-bit interpolation code.

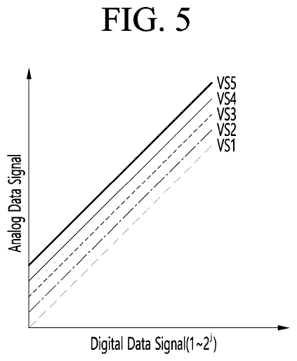

FIG. 5 is a graph showing voltages according to digital signals for q divided voltages input to the output buffer.

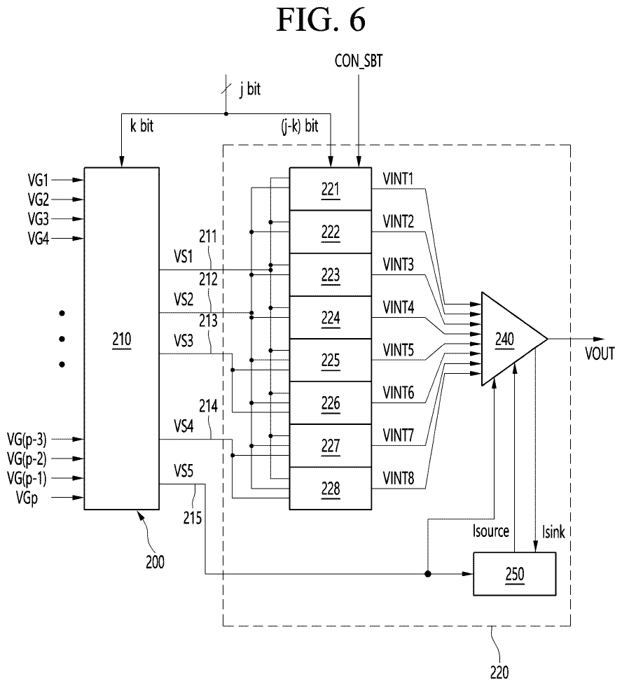

As illustrated in FIG. 5, it may be seen that as the number of bits included in the n-bit digital data signal increases, the first divided voltage VS1 to the fourth divided voltage VS4 also increase. In addition, the second divided voltage VS2 may be greater than the first divided voltage VS1, the third divided voltage VS3 may be greater than the second divided voltage VS2, and the fourth divided voltage VS4 may be greater than the third divided voltage VS3. The fifth divided voltage VS5 will be described later in the second embodiment (FIG. 6).

According to the embodiment, by interpolating the first divided voltage VS1 (the first reference voltage) and the second divided voltage VS2 (the second reference voltage) selected by each of the plurality of switches 221 to 228 during the second period T2, color reproducibility can be improved and an increase in the circuit area can be suppressed.

### Second Embodiment

FIG. 6 is a block diagram illustrating a data driving device according to a second embodiment.

The second embodiment is the same as the first embodiment (FIG. 2) except for the slew boost circuit 250. Therefore, in the second embodiment, components having the same functions as those in the first embodiment (FIG. 2) are given the same drawing reference numerals and detailed descriptions are omitted. The omitted descriptions below may be easily understood from the first embodiment (FIG. 2).

Referring to FIGS. 1 and 6, the data driving device according to the second embodiment may comprise a digital-to-analog converter 200, an output buffer 220, etc. The digital-to-analog converter 200 and the output buffer 220 may be included in one of the plurality of channels CH1 to CHn illustrated in FIG. 1. In other words, the plurality of channels CHI to CHn may each comprise the digital-to-analog converter 200 and the output buffer 220.

The digital-to-analog converter 200 may comprise a selection circuit 210, etc. The output buffer 220 may comprise a plurality of switches 221 to 228, an amplifier 240, a slew boost circuit 250, etc.

Q signal lines 211 to 215 may be connected between the digital-to-analog converter 200 and the output buffer 220.

The selection circuit 210 may select q divided voltages VS1 to VS4 among p divided voltages VG1 to VGp in response to k (<j) bit image codes constituting a j bit digital data signal. For example, the selection circuit 210 may select the first divided voltage VS1 to the fifth divided voltage VS5 and provide them to the output buffer 220 through the first signal line 211 to the fifth signal line 215. The first divided voltage VS1 may be provided through the first signal line 211, the second divided voltage VS2 may be provided through the second signal line 212, and the third divided voltage VS3 may be provided through the third signal line 213. The fourth divided voltage VS4 may be provided through the fourth signal line 214, and the fifth divided voltage VS5 may be provided through the fifth signal line 215.

The first divided voltage VS1 to the fifth divided voltage VS5 may be sequentially greater. That is, the second divided voltage VS2 may be greater than the first divided voltage VS1, and the third divided voltage VS3 may be greater than the second divided voltage VS2. The fourth divided voltage VS4 may be greater than the third divided voltage VS3, and the fifth divided voltage VS5 may be greater than the fourth divided voltage VS4. For example, the selection circuit 210 may select the first divided voltage VS1 in response to the image code of k bits. In addition, the selection circuit 210 may select the second divided voltage VS2 to the fifth divided voltage VS5 in response to the code value (or bit value) that is higher in a preset bit unit than the image code of k bits, respectively.

The plurality of switches 221 to 228 may select one of the q divided voltages VS1 to VS5 as the output voltage VINT1 to VINT8 in response to the (j-k) bit interpolation code or control signal CON_SBT constituting the j bit digital data signal and provide the selected one to the amplifier 240. The control signal CON_SBT may be generated by the data processing device 111, for example, the timing controller.

For example, in the case of a 3 bit interpolation code, the first switch 221 to the eighth switch 228 may be provided. In the case of a 4 bit interpolation code, 16 switches may be provided.

The first signal line 211 may be commonly connected to the first switch 221 to the eighth switch 228. Therefore, the first divided voltage VS1 may be provided simultaneously to the first switch 221 to the eighth switch 228 through the first signal line 211.

The second signal line 212 may be commonly connected to the first switch 221 to the eighth switch 228. Therefore, the second divided voltage VS2 may be provided simultaneously to the first switch 221 to the eighth switch 228 through the second signal line 212.

The third signal line 213 may be commonly connected to the fifth switch 225 and the sixth switch 226. Therefore, the third divided voltage VS3 may be provided simultaneously to the fifth switch 225 and the sixth switch 226 through the third signal line 213. Alternatively, the third signal line 213 may be commonly connected to the first switch 221 to the eighth switch 228 or may be commonly connected to the seventh switch 227 and the eighth switch 228.

The fourth signal line 214 may be commonly connected to the seventh signal line and the eighth signal line. Accordingly, the fourth divided voltage VS4 may be simultaneously provided to the seventh signal line and the eighth signal line through the fourth signal line 214. Alternatively, the fourth signal line 214 may be commonly connected to the first switch 221 to the eighth switch 228 or may be commonly connected to the fifth switch 225 and the sixth switch 226.

The fifth signal line 215 may be connected to the slew boost circuit 250. Accordingly, the fifth divided voltage VS5 may be provided to the slew boost circuit 250 and/or the amplifier 240.

Although the drawing illustrates that the fifth signal line 215 is connected to the slew boost circuit 250 and/or the amplifier 240 so that the fifth divided voltage VS5 is provided to the slew boost circuit 250 and/or the amplifier 240, the present invention is not limited thereto. As an example, the fifth signal line 215 may be connected to each or some of the switches 221 to 228, and one of the first signal line 211 to the fourth signal line 214 may be connected to the slew boost circuit 250 and/or the amplifier 240. As another example, the q signal lines 211 to 215 may be connected to the slew boost circuit 250 and/or the amplifier 240, and a selection circuit may be provided for selecting one divided voltage among q divided voltages VS1 to VS5 supplied through the q signal lines 211 to 215.

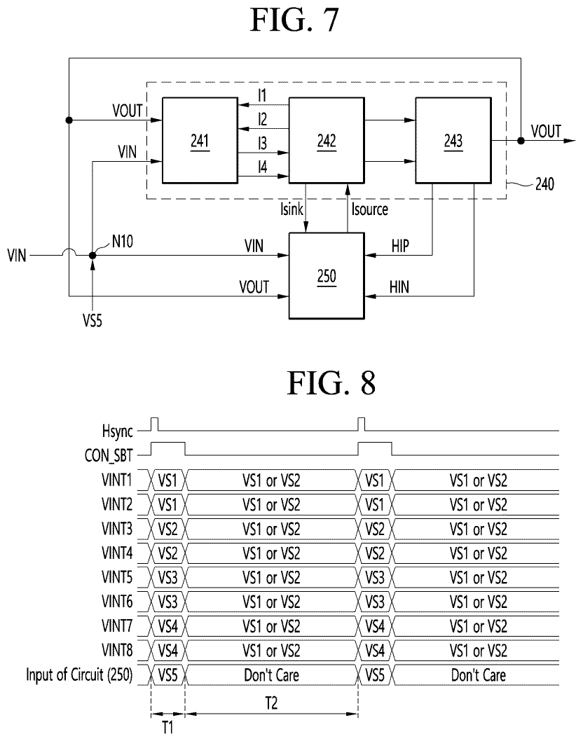

FIG. 7 is a block diagram illustrating the slew boost circuit and the amplifier of FIG. 6.

Referring to FIG. 7, the amplifier 240 may comprise an input stage 241, a current control stage 242, an output stage 243, etc.

The amplifier 240 may comprise an operational amplifier of a voltage follower structure comprising an input stage 241, a current control stage 242, and an output stage 243. The amplifier 240 may differentially amplify a difference between an input voltage VIN and an output voltage VOUT to generate an output voltage VOUT that quickly follows the input voltage VIN. Here, the input voltage VIN may be a current analog data signal input to the amplifier 240, and the output voltage VOUT may be a previous analog data signal output from the amplifier 240. Hereinafter, the input voltage VIN and the current analog data signal may be used interchangeably, and the output voltage VOUT and the previous analog data signal may be used interchangeably.

The input stage 241 may monitor the difference between the input voltage VIN input to a non-inverting terminal and the output voltage VOUT input to an inverting terminal, and control the control currents Il to 14 provided from the current control stage 242.

The current control stage 242 may generate the control currents I1 to I4 by amplifying an internal current according to the difference between the input voltage VIN and the output voltage VOUT together with the input stage 241, and may generate the output current and the control voltage HIP or HIN adjusted according to the control currents I1 to I4 and provide them to the output stage 243.

The control current I1 or I2 flowing from the current control stage 242 to the input stage 241 may be a sink current, and the control current I3 or I4 flowing from the input stage 241 to the current control stage 242 may be a source current.

The output stage 243 may output an output voltage VOUT that follows the input voltage VIN through the output terminal by performing a pull-up operation and a pull-down operation according to the control voltage HIP or HIN provided from the current control stage 242.

Meanwhile, the slew boost circuit 250 may monitor the input voltage VIN and the output voltage VOUT, as well as the control voltage HIP or HIN of the output stage 243.

The slew boost circuit 250 may operate when the difference between the input voltage VIN and the output voltage VOUT is greater than a certain voltage and the control voltage HIP or HIN of the output stage 243 becomes a gate-on voltage, thereby additionally controlling the sink current Isink or the source current Isource to increase. Here, the sink current Isink may be the second control current I2, and the source current Isource may be the fourth control current I4, but is not limited thereto. Therefore, the slew boost circuit 250 may indirectly control the output current of the current control stage 242 to increase a slew rate of the output voltage VOUT.

When both the control voltage HIP and HIN of the output stage 243 is the gate-off voltages, that is, when the input voltage VIN and the output voltage VOUT are the same, the operation of the slew boost circuit 250 may be turned off to block unnecessary current flow, so that low-power operation may be possible without increasing current consumption. The gate-on voltage may be a voltage for turning on a pull-up transistor or a pull-down transistor, and the gate-off voltage may be a voltage for turning off a pull-up transistor or a pull-down transistor.

Referring to FIG. 6 and FIG. 7, the fifth divided voltage VS5 may be provided to the slew boost circuit 250 and/or the amplifier 240 through the fifth signal line 215.

The fifth signal line 215 may be connected to a node N10 on a supply line for supplying an input voltage VIN input to the input stage 241 or the slew boost circuit 250. The fifth divided voltage VS5 may be charged to the corresponding node N10 through the fifth signal line 215. Thereafter, during the interpolation operation of the amplifier 240, the input stage 241 may increase or decrease the control current Il to 14 more significantly by using the fifth divided voltage VS5 together with the input voltage VIN. In addition, during the interpolation operation of the amplifier 240, the slew boost circuit 250 may additionally control the sink current Isink or the source current Isource to increase by using the fifth divided voltage VS5. Therefore, the slew boost circuit 250 may indirectly control the output current of the current control stage 242 by using the fifth divided voltage VS5 provided through the fifth signal line 215. Therefore, the settling time can be improved by using the fifth divided voltage VS5 pre-charged to the node N10, so that the output speed of the output voltage can be increased.

In the drawing, the fifth signal line 215 is illustrated as being fixedly connected to the slew boost circuit 250.

Alternatively, the first signal line 211 to the fifth signal line 215 may be commonly connected to the slew boost circuit 250. In this instance, during the first period T1, one of the first division voltages VS1 to VS5 provided through the first signal line 211 to the fifth signal line 215 may be selected and provided to the slew boost circuit 250. A separate selection circuit may be provided to select one of the first division voltages VS1 to VS5. For example, one of the first division voltages VS1 to VS5 may be selected in response to a separate control signal. For example, the control signal may be a control signal for selecting a division voltage having the largest difference from a previous analog data signal VOUT output from the amplifier 240. The control signal may be generated in the data processing device 111. For example, during the first period T1, a divided voltage having the largest difference from the previous analog data signal VOUT among the first divided voltage VS1 to the fifth divided voltage VS5 may be selected according to the corresponding control signal, and the selected divided voltage may be provided to the slew boost circuit 250 and/or the amplifier 240. Accordingly, the slew boost circuit 250 and the amplifier 240 may further increase the slew rate of the output voltage VOUT by using the selected divided voltage, respectively.

FIG. 8 is an operation timing diagram of a data driving device according to the second embodiment.

Referring to FIGS. 6 to 8, it may be divided into a first period T1 and a second period T2 using the horizontal sync signal Hsync.

The plurality of switches 221 to 228 may be switched and controlled according to the control signal CON_SBT during the first period T1, and may be switched and controlled according to the (j-k)-bit interpolation code during the second period T2.

During the first period T1, one of the first to fourth divided voltages VS1 to VS4 may be selected as the output voltage VINT1 to VINT8 through the plurality of switches 221 to 228, so that the selected output voltages VINT1 to VINT8 may be provided to the amplifier 240. Accordingly, the input signal of the amplifier 240 can be quickly initialized or pre-charged to a specific voltage level, thereby improving the settling time and increasing the output speed.

During the second period T2, the color reproducibility can be improved and the circuit area can be suppressed from increasing by interpolating based on the first divided voltage VS1 (the first reference voltage) and the second divided voltage VS2 (the second reference voltage) through the plurality of switches 221 to 228.

Meanwhile, during the first period T1, one divided voltage, for example, the fifth divided voltage VS5, may be provided to the slew boost circuit 250 and/or the amplifier 240. Accordingly, the fifth divided voltage VS5 may be charged to the node N10 during the first period T1. In addition, the fifth divided voltage VS5 may be provided to the slew boost circuit 250 and/or the amplifier 240 while being charged to the node N10. However, the slew boost circuit 250 and/or the amplifier 240 may not be operated during the first period T1 and may be maintained in a standby state. Thereafter, during the interpolation operation of the amplifier 240 in the second period T2, the fifth divided voltage VS5 charged to the node N10 may be supplied to the slew boost circuit 250 and/or the amplifier 240 more quickly. Accordingly, the input stage 241 of the amplifier 240 may more quickly increase or decrease the control currents I1 to I4 based on the fifth divided voltage VS5, thereby improving the settling time and increasing the output speed. At the same time, the slew boost circuit 250 can improve the settling time and increase the output speed by additionally controlling the sink current Isink or the source current Isource to increase by using the fifth divided voltage VS5.

According to the embodiment, by independently using one of the plurality of divided voltages VS1 to VS5 output from the selection circuit 210 as an input to the slew boost circuit 250 and/or the amplifier 240, the control current of the slew boost circuit 250 and/or the amplifier 240 can be increased or decreased more quickly. Therefore, the settling time of the slew boost circuit 250 and/or the amplifier 240 can be improved by the independently input divided voltage VS5, thereby increasing the output speed of the amplifier.

### Third Embodiment

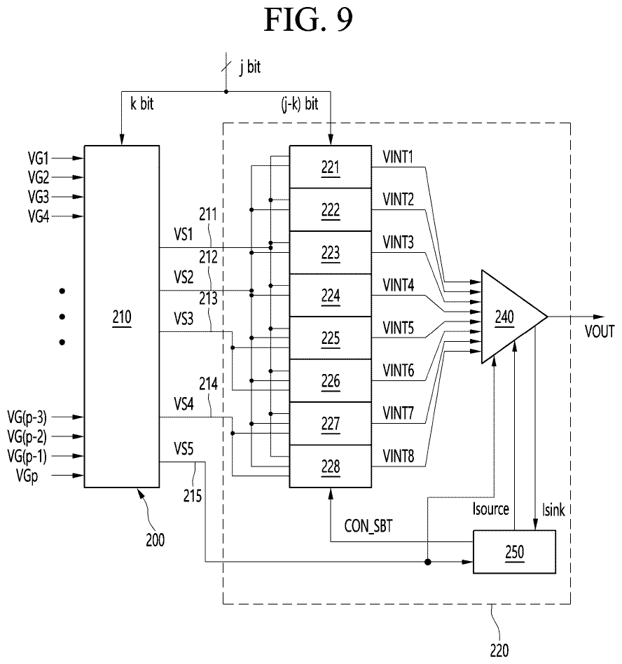

FIG. 9 is a block diagram illustrating a data driving device according to a third embodiment.

The third embodiment is the same as the second embodiment (FIG. 6) except that the control signal CON_SBT generated in the slew boost circuit 250 is provided to the plurality of switches 221 to 228.

Therefore, in the third embodiment, components having the same functions as in the second embodiment (FIG. 6) are given the same reference numerals and detailed descriptions are omitted. The omitted descriptions below may be easily understood from the second embodiment (FIG. 6).

Referring to FIGS. 1 and 9, the data driving device according to the third embodiment may comprise a digital-to-analog converter 200, an output buffer 220, etc. The digital-to-analog converter 200 and the output buffer 220 may be included in one of the plurality of channels CH1 to CHn illustrated in FIG. 1. In other words, the plurality of channels CH1 to CHn may each comprise the digital-to-analog converter 200 and the output buffer 220.

The digital-to-analog converter 200 may comprise a selection circuit 210, etc. The output buffer 220 may comprise a plurality of switches 221 to 228, an amplifier 240, a slew boost circuit 250, etc.

The selection circuit 210 may select q (<p) divided voltages VS1 to VS5 from among p divided voltages VG1 to VGp. The q divided voltages VS1 to VS5 may be provided to the output buffer 220 through q signal lines 211 to 215. Among the q divided voltages VS1 to VS5, a first divided voltage VS1 may be a first reference voltage, and a second divided voltage VS2 may be a second reference voltage. The first reference voltage and the second reference voltage may be used for interpolation of the amplifier 240.

Among the q signal lines 211 to 215, the first signal line 211 to the fourth signal line 214 may be connected to the plurality of switches 221 to 228, and the fifth signal line 215 may be connected to the slew boost circuit 250 and/or the amplifier 240.

The plurality of switches 221 to 228 may be connected to two or more signal lines among the first signal line 211 to the fourth signal line 214, respectively. Accordingly, two or more divided voltages among the p divided voltages VG1 to VGp provided by the selection circuit 210 may be provided to the plurality of switches 221 to 228 through the two or more signal lines.

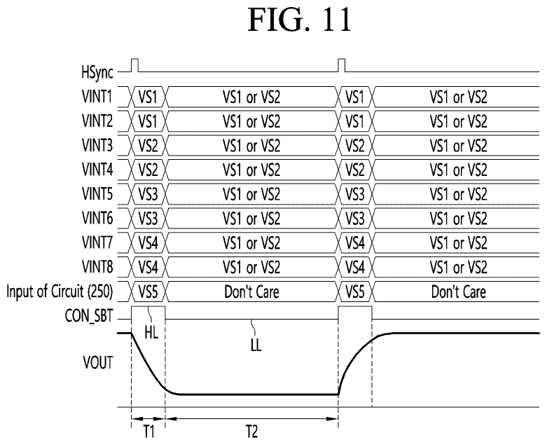

Meanwhile, the output buffer 220 may be operated by dividing into a first period (T1 of FIG. 11) and a second period T2.

For example, during the first period T1, the plurality of switches 221 to 228 may provide one of two or more divided voltages provided through two or more signal lines as the output voltage VINT1 to VINT8 to the amplifier 240. The amplifier 240 may initialize an input signal on the input side of the amplifier 240 to a specific voltage level by using the output voltages VINT1 to VINT8 provided from the plurality of switches 221 to 228. Since the plurality of output voltages VINT1 to VINT8 are provided to the input side of the amplifier 240 through a plurality of paths by using the plurality of switches 221 to 228, a fast settling time can be secured, so that the output speed of the amplifier 240 can be increased.

For example, during the second period T2, the plurality of switches 221 to 228 may provide the first divided voltage VS1 (the first reference voltage) or the second divided voltage VS2 (the second reference voltage) among two or more divided voltages provided through two signal lines as the output voltage VINT1 to VINT8 to the amplifier 240. The amplifier 240 may interpolate the first reference voltage VS1 or the second reference voltage VS2 provided from each of the plurality of switches 221 to 228, and output an analog data signal of a desired grayscale onto the panel 105.

Meanwhile, among the p divided voltages VG1 to VGp provided from the selection circuit 210, one divided voltage VS5 may be provided to the slew boost circuit 250 and/or the amplifier 240 through the fifth signal line 215. Although the drawing illustrates that the fifth signal line 215 is connected to the slew boost circuit 250 and/or the amplifier 240 so that the fifth divided voltage is provided to the slew boost circuit 250 and/or the amplifier 240, the present invention is not limited thereto.

In an embodiment, the slew boost circuit 250 may output a control signal CON_SBT to a plurality of switches 221 to 228 using the fifth divided voltage VS5.

The operation of the plurality of switches 221 to 228 may be controlled according to the control signal CON_SBT.

For example, during a first period T1, the plurality of switches 221 to 228 may be operated by the control signal CON_SBT, and during a second period T2, the plurality of switches 221 to 228 may be operated by an (j-k)-bit interpolation code.

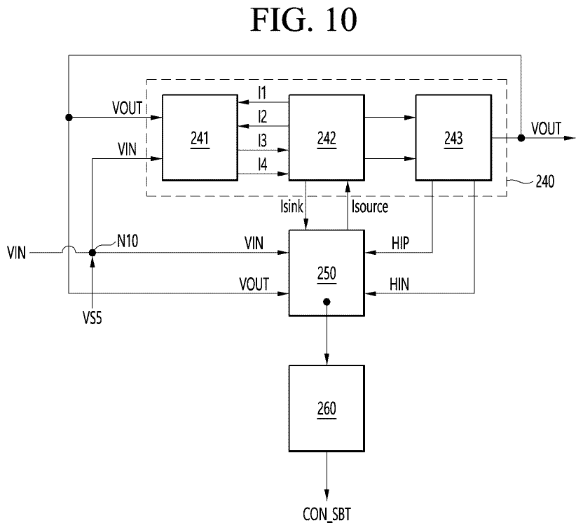

As illustrated in FIG. 10, the fifth signal line 215 may be connected to the node N10 on the supply line. Through the supply line, the input voltage VIN, i.e., the current analog data signal, may be input to the input stage 241 of the slew boost circuit 250 and/or the amplifier 240.

The input voltage VIN may be obtained through interpolation of the divided voltages selected by the operation of the plurality of switches 221 to 228 during the second period T2, but is not limited thereto.

Since the input voltage VIN is obtained during the second period T2, the input voltage VIN may not be input to the input stage 241 of the slew boost circuit 250 and/or the amplifier 240 during the first period T1 through the supply line.

Instead, the fifth division voltage VS5 provided through the fifth signal line 215 during the first period T1 may be input to the input stage 241 of the slew boost circuit 250 and/or the amplifier 240. In this instance, the slew boost circuit 250 may obtain the control signal CON SBT based on the fifth division voltage VS5 provided through the fifth signal line 215 and the previous analog data signal VOUT output from the amplifier 240.

The fifth division voltage VS5 and the previous analog data signal VOUT may be input to the slew boost circuit 250. The control currents Isink and Isource of the slew boost circuit 250 may be changed by the fifth division voltage VS5. That is, the control currents Isink and Isource may be changed according to the difference between the fifth division voltage VS5 and the previous analog data signal VOUT. That is, the magnitude of the control currents Isink and Isource may vary depending on the difference between the fifth divided voltage VS5 and the previous analog data signal VOUT.

Meanwhile, the data driving device according to the third embodiment may comprise a control signal generation circuit 260. Although the control signal generation circuit 260 is illustrated in the drawing as being provided separately from the slew boost circuit 250, it may be included in the slew boost circuit 250.

The control signal generation circuit 260 may generate the control signal CON_SBT based on the control currents Isink and Isource. That is, the control signal generation circuit 260 may generate the control signal CON_SBT based on the difference between the fifth divided voltage VS5 and the previous analog data signal VOUT. The level of the control signal CON_SBT may vary depending on the difference between the fifth divided voltage VS5 and the previous analog data signal VOUT.

The control signal generation circuit 260 may be connected to an internal wiring within the slew boost circuit 250. The internal wiring may be a wiring through which the control current Isink flows or a wiring through which the control current Isource flows. Accordingly, when the corresponding control currents Isink and Isource are changed by the input of the fifth divided voltage VS5, the changed control currents Isink and Isource may be provided to the control signal generation circuit 260.

The control signal generation circuit 260 may comprise an integrator or at least one inverter, but is not limited thereto.

The integrator may integrate the control currents Isink and Isource and output a control signal CON_SBT in the form of a voltage. The level of the control signal CON_SBT may vary depending on the magnitude of the control current. For example, the level of the control signal CON_SBT may increase as the magnitude of the control current increases.

The at least one inverter may output a digital control signal CON_SBT based on linearly changing control currents Isink and Isource. For example, when the control currents Isink and Isource are changed within a preset range, the at least one inverter may output a low-level control signal CON_SBT. For example, when the control currents Isink and Isource are changed outside a preset range, the at least one inverter may output a high-level control signal CON_SBT.

Referring to FIGS. 9 and 10, during a first period T1, the amplifier 240 may initialize or pre-charge the input side of the amplifier 240 to a specific voltage level using the output voltage VINT1 to VINT8 output from each of the plurality of switches 221 to 228.

According to an embodiment, there is no need to separately generate the control signal CON_SBT using digital logic, so that the circuit area can be reduced.

According to the embodiment, since the control signal CON_SBT generated from the slew boost circuit 250 is directly provided to the plurality of switches 221 to 228, the signal transmission path can be minimized, thereby preventing malfunction due to signal loss.

Meanwhile, as described above, during the second period T2, each of the plurality of switches 221 to 228 may output the first divided voltage VS1 (the first reference voltage) or the second divided voltage VS2 (the second reference voltage) as the output voltage VINT1 to VINT8 to the amplifier 240. During the second period T2, the amplifier 240 may interpolate the output voltages VINT1 to VINT8 provided from the plurality of switches 221 to 228, and supply an analog data signal of a desired grayscale to the panel 105.

FIG. 11 is an operation timing diagram of a data driving device according to the third embodiment.

Referring to FIG. 9 and FIG. 11, the control signal CON_SBT may have a first signal HL (high level) and a second signal LL (low level). When one of the q divided voltages VSI to VS5, for example, the fifth divided voltage VS5, is input to the slew boost circuit 250 during the first period T1, the control currents Isink and Isource may be changed according to the difference between the fifth divided voltage VS5 and the previous analog data signal VOUT. The first signal HL of the control signal CON_SBT may be generated by the change in the control currents Isink and Isource. When there is no difference between the fifth divided voltage VS5 and the previous analog data signal VOUT, the first signal HL may not be generated. In this instance, the second signal LL may be generated throughout the first period T1 and the second period T2. The first signal HL of the control signal CON_SBT may or may not be generated.

Meanwhile, the previous analog data signal VOUT may be changed to a specific voltage level initialized during the first period T1. Therefore, the difference between the fifth divided voltage VS5 and the previous analog data signal VOUT may gradually decrease according to the change of the previous analog data signal VOUT. In this way, the difference may decrease, and at some time point, when the previous analog data signal VOUT matches the fifth divided voltage VS5, or when the difference between the fifth divided voltage VS5 and the previous analog data signal VOUT falls within a certain range, the second signal LL of the control signal CON_SBT may be generated.

For example, the first period T1 and the second period T2 may be distinguished using the first signal HL and the second signal LL of the control signal CON_SBT, respectively, but is not limited thereto. That is, the first period T1 may be defined in synchronization with the first signal HL of the control signal CON_SBT, and the second period T2 may be defined in synchronization with the second signal LL of the control signal CON_SBT. For example, a first period T1 may be defined in response to a high level section of a first signal HL of the control signal CON_SBT, and a second period T2 may be defined in response to a second signal LL of the control signal CON_SBT.

Alternatively, a first signal HL of the control signal CON_SBT may be generated during the first period T1, and a second signal LL of the control signal CON_SBT may be generated during the second period T2.

In response to a first signal HL of a control signal CON_SBT, each of the plurality of switches 221 to 228 may be turned on so that one of two or more divided voltages provided through two or more signal lines may be provided as the output voltage VINT1 to VINT8 to the amplifier 240. The amplifier 240 may initialize or pre-charge an input side of the amplifier 240 to a specific voltage level using the output voltage VINT1 to VINT8 provided through each of the plurality of switches 221 to 228. Accordingly, the output speed of the amplifier 240 can be increased by achieving faster settling during the first period T1.

Depending on the level of the first signal HL of the control signal CON_SBT, the selected divided voltages of each of the plurality of switches 221 to 228 may vary. As the level of the first signal HL is higher, each of the plurality of switches 221 to 228 may select a higher divided voltage.

For example, as illustrated in FIG. 11, when the level of the first signal HL is low, the first switch and the second switch may each select the first divided voltage VS1, the third switch and the fourth switch may each select the second divided voltage VS2, the fifth switch and the sixth switch may each select the third divided voltage, and the seventh switch and the eighth switch may each select the fourth divided voltage.

For example, when the level of the first signal HL is high, the first to fourth switches may select the third divided voltage, respectively, and the fifth to eighth switches may select the fourth divided voltage. To this end, the q signal lines 211 to 215 may be connected to the plurality of switches 221 to 228, respectively. In addition, in various ways, different divided voltages may be selected from the plurality of switches 221 to 228 according to the level of the first signal HL of the control signal CON_SBT.

Meanwhile, when the second period T2 is defined by synchronizing with the second signal LL of the control signal CON_SBT, the plurality of switches 221 to 228 may be operated using an (j-k)-bit interpolation code only when the second signal LL of the control signal CON_SBT is provided to the plurality of switches 221 to 228.

In contrast, when the second signal LL of the control signal CON_SBT is not related to the second period T2, the plurality of switches 221 to 228 may not be operated by the second signal LL of the control signal CON_SBT. Instead, the plurality of switches 221 to 228 may be operated by using an (j-k)-bit interpolation code during the second period T2 defined by using the vertical synchronization signal (Hsync) as described above. The operations of the plurality of switches 221 to 228 and the interpolation operation of the amplifier 240 during the second period T2 have been described above, so that they will be omitted.

Meanwhile, as described above, since the input side of the amplifier 240 is initialized or pre-charged to a specific voltage level during the first period T1, the output of the amplifier 240 may also be changed to an analog data signal VOUT corresponding to a specific voltage level. For example, as illustrated in FIG. 11, the analog data signal VOUT output from the amplifier 240 can be reduced to a specific voltage level. This is only an example, and the analog data signal VOUT may also be increased to a specific voltage level.

An analog data signal VOUT having a desired grayscale may be output through interpolation of the amplifier 240 during the second period T2.

The analog data signal VOUT illustrated in FIG. 11 may be a current analog data signal that is increased or decreased from the previous analog data signal VOUT according to the grayscale. Accordingly, the specific voltage level may be set to an intermediate value between the previous analog data signal and the current analog data signal, but is not limited thereto.

The above detailed description should not be construed as limiting in all respects and should be considered illustrative. The scope of the embodiment should be determined by reasonable interpretation of the appended claims, and all changes within the equivalent range of the embodiment are included in the scope of the embodiment.

1. A data driving device, comprising:
a selection circuit configured to select q (<p) divided voltages from among p divided voltages in response to a k (<j) bit image code constituting a j-bit digital data signal;
a plurality of switches connected to the selection circuit and configured to output output voltages;
an amplifier configured to output an analog data signal using the output voltages; and
a slew boost circuit configured to receive one divided voltage from among the q divided voltages and configured to output a control signal to the plurality of switches using the one divided voltage.

2. The data driving device of claim 1, wherein each of the plurality of switches is connected to two or more signal lines from among q signal lines connected to the selection circuit, and is configured to receive two or more divided voltages provided through the two or more signal lines in response to the control signal during a first period and output one divided voltage from among the two or more divided voltages as an output voltage.

3. The data driving device of claim 1, wherein the slew boost circuit is configured to obtains the control signal based on the input one divided voltage and a previous analog data signal output from the amplifier.

4. The data driving device of claim 3, wherein a level of the control signal is configured to vary according to a difference between the input one divided voltage and the previous analog data signal.

5. The data driving device of claim 4, wherein a divided voltage selected from each of the plurality of switches is configured to vary according to the level of the control signal.

6. The data driving device of claim 1, comprising a control signal generation circuit configured to generate the control signal.

7. The data driving device of claim 6, wherein the control signal generation circuit is configured to generate the control signal having a different level based on a difference between an input one divided voltage and an previous analog data signal output from the amplifier.

8. The data driving device of claim 6, wherein the control signal generation circuit comprises an integrator or at least one inverter.

9. The data driving device of claim 1, wherein the q divided voltages comprise a first reference voltage, a second reference voltage, and remaining voltages, and
wherein each of the plurality of switches is configured to select one voltage from among the first reference voltage and the second reference voltage as an output voltage in response to an (j-k)-bit interpolation code constituting the j-bit digital data signal for a second period and output the selected output voltage to the amplifier.

10. A display device, comprising:
a panel comprising a plurality of gate lines and a plurality of data lines; and
a data driving device configured to drive the plurality of data lines,
wherein the data driving device comprises:
a selection circuit configured to select q (<p) divided voltages from among p divided voltages in response to a k (<j) bit image code constituting a j-bit digital data signal;
a plurality of switches connected to the selection circuit and configured to output output voltages;
an amplifier configured to output an analog data signal using the output voltages; and
a slew boost circuit configured to receive one divided voltage from among the q divided voltages and configured to output a control signal to the plurality of switches using the one divided voltage.
